(19) United States
(12) Patent Application Publication
(10) Pub. No.: US 2026/0254350 A1
(43) Pub. Date: Aug. 27, 2026

(54) SWITCHING OPERATION CONTROL FOR POWER CIRCUIT AND METHOD THEREOF

(71) Applicant: Chengdu Monolithic Power Systems Co., Ltd., Chengdu (CN)

(72) Inventors: Chuanhao Xu, Hangzhou (CN); Pengfei Liu, Hangzhou (CN); Fang Han, Hangzhou (CN); Siran Wang, Hangzhou (CN)

(21) Appl. No.: 19/551,803

(22) Filed: Feb. 27, 2026

(30) Foreign Application Priority Data
Feb. 27, 2025 (CN) 202510228063.0

(51) Int. Cl. H02M 1/42; H02M 3/158

(52) U.S. Cl. CPC H02M 1/4225; H02M 3/158

(57) ABSTRACT

A control circuit for a power circuit having a first switch is provided. The control circuit includes a valley detection circuit, a timing circuit and a switching control circuit. The valley detection circuit detects a first switch voltage across the first switch and provides a voltage valley signal indicating a valley of the first switch voltage. The timing circuit provides a demagnetization time signal indicating a demagnetization time of an inductor of the power circuit based on the voltage valley signal. The switching control circuit provides a switching control signal to control the first switch based on the demagnetization time signal and an on-period signal. When a ratio of the demagnetization time signal to the on-period signal is larger than a stop threshold, the switching control signal turns off the first switch and stops the switching operation of the first switch.

### CROSS-REFERENCE TO RELATED APPLICATIONS

This application claims the benefit of and priority to a CN application 202510228063.0, filed on Feb. 27, 2025, which is incorporated herein by reference into the present application.

### TECHNICAL FIELD

The present disclosure relates generally to electronic circuits, and more particularly but not exclusively to power circuits and boost Power Factor Correction (PFC) circuits.

### BACKGROUND OF THE INVENTION

Boost PFC circuit converts an input voltage into an output voltage higher than the input voltage. In practical applications, the efficiency of the boost PFC circuit is often improved by reducing the difference between the output voltage and the input voltage, but the output voltage may be equal or even lower than the input voltage due to output voltage ripples. In such instances, an inductor of the boost PFC circuit may not be completely demagnetized, leading to abnormal operation of the circuit accompanied by audio noise and thermal issues. One common solution is to maintain a sufficient margin between the output voltage and the input voltage to ensure normal operation of the circuit, however, the efficiency and the cost of the circuit are compromised.

Therefore, it is desired to improve efficiency while ensuring the normal operation of the circuit.

### SUMMARY OF THE INVENTION

According to an embodiment of the present disclosure, a control circuit for a power circuit having a first switch is provided. The control circuit includes a valley detection circuit, a timing circuit and a switching control circuit. The valley detection circuit detects a first switch voltage across the first switch and provides a voltage valley signal indicating a valley of the first switch voltage. The timing circuit provides a demagnetization time signal indicating a demagnetization time of an inductor of the power circuit based on the voltage valley signal. The switching control circuit provides a switching control signal to control the first switch based on the demagnetization time signal and an on-period signal. When a ratio of the demagnetization time signal to the on-period signal is larger than a stop threshold, the switching control signal turns off the first switch and stops a switching operation of the first switch.

According to another embodiment of the present disclosure, a control circuit for a boost PFC circuit having a first switch is provided. The control circuit includes a zero-current detection circuit, a timing circuit and a switching control circuit. The zero-current detection circuit detects an inductor current flowing through an inductor of the boost PFC circuit, and provides a zero-crossing signal indicating the inductor current reaches essentially zero. The timing circuit provides a demagnetization time signal indicating a demagnetization time of the inductor based on the zero-crossing signal. The switching control circuit provides a switching control signal to control the first switch based on the demagnetization time signal and an on-period signal. The switching control circuit determines whether to control the first switch to enter a soft-off mode based on the demagnetization time signal and the on-period signal, and when the first switch enters the soft-off mode, an on-period of the switching control signal gradually decreases.

According to yet another embodiment of the present disclosure, a method for controlling a power circuit is provided. The method includes the following actions. A first switch voltage across a first switch of the power circuit is detected, and a voltage valley signal indicating a valley of the first switch voltage is provided. A demagnetization time signal indicating a demagnetization time of an inductor of the power circuit is provided based on the voltage valley signal. A switching control signal is provided to control the first switch based on the demagnetization time signal and an on-period signal. When a ratio of the demagnetization time signal to the on-period signal is larger than a stop threshold, the first switch is turned off and a switching operation of the first switch is stopped.

### BRIEF DESCRIPTION OF THE DRAWINGS

The present disclosure can be further understood with reference to the following detailed description and appended drawings, where like elements are provided with like reference numerals. These drawings are only for illustration purpose, thus may only show part of the device and are not necessarily drawn to scale.

FIG. 1 schematically shows a schematic circuit diagram of a boost PFC circuit in accordance with one embodiment of the present disclosure.

FIG. 2 schematically shows a simulated waveform illustrating a working principle of a boost PFC circuit in accordance with one embodiment of the present disclosure.

FIG. 3 schematically shows a schematic block diagram of a switching control circuit in accordance with one embodiment of the present disclosure.

FIG. 4 schematically shows a simulated waveform illustrating a working principle of a boost PFC circuit in accordance with one embodiment of the present disclosure.

FIG. 5 schematically shows a schematic block diagram of a switching control circuit in accordance with another embodiment of the present disclosure.

FIG. 6 schematically shows a simulated waveform illustrating a working principle of a boost PFC circuit in accordance with another embodiment of the present disclosure.

FIG. 7 schematically shows a schematic circuit diagram of a boost PFC circuit in accordance with another embodiment of the present disclosure.

FIG. 8 schematically shows a schematic block diagram of a switching control circuit shown in FIG. 7 in accordance with one embodiment of the present disclosure.

FIG. 9 shows a flowchart of a method for controlling a power circuit in accordance with one embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in one embodiment”, “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

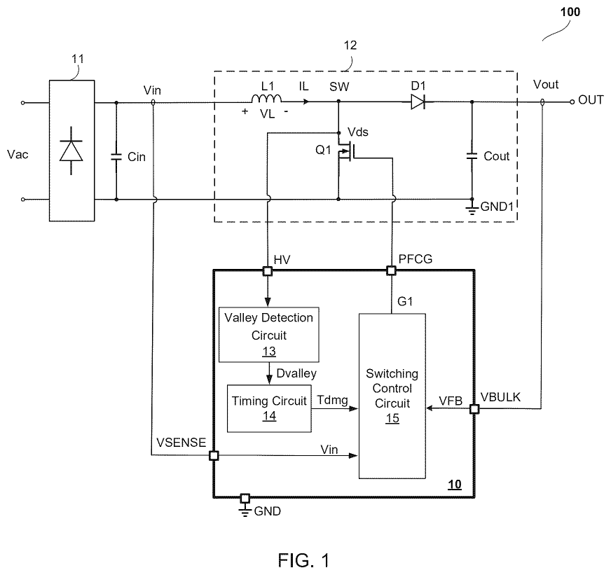

FIG. 1 schematically shows a schematic circuit diagram of a boost PFC circuit 100 in accordance with one embodiment of the present disclosure. As shown in FIG. 1, the boost PFC circuit 100 includes two input terminals for receiving an AC input voltage Vac, an output terminal OUT for providing an output voltage Vout, and a reference ground GND1. In the embodiment of FIG. 1, the boost PFC circuit 100 includes a rectifying circuit 11, a boost conversion circuit 12, and a control circuit 10. The rectifying circuit 11 is coupled to the two input terminals of the boost PFC circuit 100 to receive and rectify the AC input voltage Vac. After rectification, a half-sine wave is obtained, and then it is filtered by an input capacitor Cin to provide an input rectified voltage Vin. The boost conversion circuit 12 receives the input rectified voltage Vin and converts it into the output voltage Vout that meets the requirements of the load (not shown in FIG. 1). The control circuit 10 is configured to provide a switching control signal G1 to control the boost conversion circuit 12.

In the embodiment of FIG. 1, the boost conversion circuit 12 includes an inductor L1, a first switch Q1, a second switch D1, and an output capacitor Cout. The inductor L1 is coupled between the rectifying circuit 11 and a switching terminal SW. The first switch Q1 is coupled between the switching terminal SW and the reference ground GND1. The second switch D1 is coupled between the switching terminal SW and the output terminal OUT. The output capacitor Cout is coupled between the output terminal OUT and the reference ground GND1. In one embodiment, the first switch Q1 is a metal-oxide-semiconductor field-effect transistor (MOSFET), and the second switch D1 is a diode. It should be appreciated that the first switch Q1 may be realized by other suitable controllable switches, and the second switch D1 may also be a controllable switch (e.g., a MOSFET). In some embodiments, when the second switch D1 is adopted by the controllable switch, the switching control signal G1 may be used to control the second switch D1.

In the embodiment of FIG. 1, the control circuit 10 is an integrated circuit (IC) including a valley detection circuit 13, a timing circuit 14, a switching control circuit 15, and a plurality of terminals. For example, the plurality of terminals includes a valley detection terminal HV, a driving terminal PFCG, an input voltage detection terminal VSENSE, an output voltage sampling terminal VBULK, and a ground terminal GND. As shown in FIG. 1, the valley detection terminal HV is configured to be coupled to the first terminal of the first switch Q1 to receive a first switch voltage Vds indicating the voltage across the first switch Q1. The driving terminal PFCG is configured to provide the switching control signal G1 to the first switch Q1. The input voltage detection terminal VSENSE is configured to receive the input rectified voltage Vin. The output voltage sampling terminal VBULK is configured to receive a feedback voltage signal VFB indicating the output voltage Vout. In one embodiment, the output voltage Vout may be directly provided to the control circuit 10 as the feedback voltage signal VFB. In another embodiment, the boost PFC circuit 100 further includes a voltage dividing circuit. The output voltage Vout is obtained as a divided voltage by the voltage dividing circuit, and the divided voltage is provided to the control circuit 10 as the feedback voltage signal VFB.

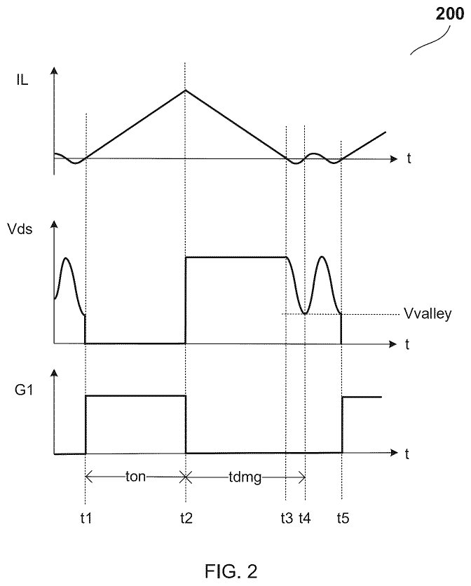

FIG. 2 schematically shows a simulated waveform 200 illustrating a working principle of the boost PFC circuit 100 in accordance with one embodiment of the present disclosure. The working principle of the boost PFC circuit 100 is described with reference to FIGS. 1 and 2. In the embodiment of FIG. 2, the first switch Q1 is turned on when the switching control signal G1 is at a high voltage level. The first switch Q1 is turned off when the switching control signal G1 is at a low voltage level.

As shown in FIG. 2, at time t1, the switching control signal G1 transitions to the high voltage level, the first switch Q1 is turned on, and the first switch voltage Vds transitions to a low voltage level. The input rectified voltage Vin charges the inductor L1. The inductor L1 is magnetized and stores energy, and an inductor current IL increases. At this time, the voltage VL across the inductor L1 is equal to the input rectified voltage Vin, and the output capacitor Cout powers to the load. At time t2, the switching control signal G1 transitions to the low voltage level, the first switch Q1 is turned off, and the first switch voltage Vds transitions to a high voltage level. The inductor L1 is demagnetized and releases the stored energy, and the inductor current IL decreases. At this time, the voltage VL across the inductor L1 is equal to the difference between the output voltage Vout and the input rectified voltage Vin. The input rectified voltage Vin and the inductor L1 charge the output capacitor Cout and power the load.

At time t3, the inductor current IL crosses essentially zero for the first time (i.e., the first zero-crossing point of the inductor current IL). Due to the parasitic capacitance of the first switch Q1, the inductor current IL and the first switch voltage Vds start to oscillate. At time t4, the inductor current IL crosses essentially zero for the second time (i.e., the second zero-crossing point of the inductor current IL), the first switch voltage Vds decreases essentially to its valley Vvalley, and the demagnetization of the inductor L1 ends. That is to say, in the embodiment shown in FIG. 2, the moment when the inductor current IL crosses essentially zero for the second time (i.e., the moment when the first switch voltage Vds decreases essentially to its valley Vvalley) is defined as the end of the demagnetization. It should be understood that, in other embodiments, the end of the demagnetization may be other suitable moment before or after the first zero-crossing point of the inductor current IL. For example, the end of the demagnetization of the inductor L1 may be a moment located within the time t3-t4 shown in FIG. 2.

It is to be understood that “substantially” is a term of art, and is meant to convey the principle that relationship such simultaneity or perfect synchronization cannot be met with exactness, but only within the tolerances of the technology available to a practitioner of the art under discussion. For example, the zero-crossing point of the inductor current IL may refer to when the inductor current IL crosses a current value within a range of zero (e.g., ±0.5 A).

At time t5, the switching control signal G1 transitions to the high voltage level, the first switch Q1 is turned on. The first switch voltage Vds transitions to the low voltage level, the inductor current IL increases, and a new operating cycle starts. According to the volt-second balance, the relationship between the voltage VL across the inductor L1 and the time duration of energy storage/release of the inductor L1 could be expressed as:

$$\frac{V in}{L} \times ton = \frac{( V out - V in )}{L} \times tdmg , \qquad ( 1 )$$

where L represents the inductance of the inductor L1, ton represents the on-period of the switching control signal G1, and tdmg represents the demagnetization time of the inductor L1. The equation (1) could be simplified as:

$$\frac{tdmg}{ton} = \frac{1}{\frac{V out}{V in} - 1} \qquad ( 2 )$$

It could be shown in equation (2) that the relationship between the input rectified voltage Vin and the output voltage Vout could be represented by the demagnetization time tdmg and the on-period ton.

Therefore, the control circuit of the present disclosure determines the relationship between the input rectified voltage Vin and the output voltage Vout based on the demagnetization time tdmg of the inductor L1 and the on-period ton of the switching control signal G1. When the input rectified voltage Vin approaches the output voltage Vout, the control circuit turns off the first switch Q1 and stops the switching operation of the first switch Q1, thus the inductor L1 could be demagnetized completely to ensure the normal operation of the circuit. In other words, the boost PFC circuit in the embodiments of the present disclosure could maintain normal operation even when the difference between the output voltage Vout and the input rectified voltage Vin is relatively small, thereby improving efficiency and reducing cost. For example, for conventional boost PFC circuit, when the AC input voltage Vac of the boost PFC circuit ranges from 80V to 264V, the output voltage Vout is typically controlled around 400V to ensure normal operation. In contrast, the boost PFC circuit of the present disclosure allows the output voltage Vout to be controlled around 360V while maintaining normal operation.

Referring back to FIG. 1, the valley detection circuit 13 is configured to detect the first switch voltage Vds across the first switch Q1, and to provide a voltage valley signal Dvalley indicating the valley of the first switch voltage Vds. In one embodiment, when the first switch voltage Vds reaches essentially its valley, the voltage valley signal Dvalley provides a pulse to indicate this moment. It should be understood that the voltage valley signal Dvalley may utilize other forms to indicate the valley of the first switch voltage Vds, such as the rising edge, the falling edge, or the specific voltage level. For instance, when the first switch voltage Vds is at the high voltage level, the voltage valley signal Dvalley is at a first voltage level; when the first switch voltage Vds is at the low voltage level, the voltage valley signal Dvalley is at a second voltage level; and when the first switch voltage Vds reaches its valley, the voltage valley signal Dvalley is at a third voltage level.

The timing circuit 14 is configured to provide the demagnetization time signal Tdmg based on the voltage valley signal Dvalley indicating the demagnetization time tdmg of the inductor L1. In some embodiments, the timing circuit 14 is configured to measure the duration from the moment when the first switch voltage Vds transitions from the low voltage level to the high voltage level to the moment when the first switch voltage Vds decreases essentially to its valley Vvalley as the demagnetization time tdmg (e.g., time t2-t4 shown in FIG. 2) of the inductor L1, and to provide the demagnetization time signal Tdmg indicating the demagnetization time tdmg of the inductor L1.

In other embodiments, the timing circuit 14 is configured to receive the switching control signal G1. In that case, the timing circuit 14 is configured to measure the duration from the moment when the switching control signal G1 transitions from the high voltage level to the low voltage level to the moment when the first switch voltage Vds decreases essentially to its valley Vvalley as the demagnetization time tdmg of the inductor L1, and to provide the demagnetization time signal Tdmg indicating the demagnetization time tdmg of the inductor L1. In other words, the timing circuit 14 determines the time when the first switch voltage Vds decreases essentially to its valley Vvalley as the end of the demagnetization. In one embodiment, the time when the first switch voltage Vds decreases to its valley Vvalley could be obtained by detecting the voltage value of the first switch voltage Vds. In another embodiment, the time when the first switch voltage Vds decreases to its valley Vvalley could be obtained by detecting the slew rate of the first switch voltage Vds.

It should be understood that other signals related to the demagnetization time tdmg of the inductor L1 may also be used to obtain the demagnetization time tdmg of the inductor L1. In some embodiments, the timing circuit 14 may obtain the demagnetization time tdmg of the inductor L1 based on the inductor current IL flowing through the inductor L1. For example, the timing circuit 14 is configured to measure the duration from the moment when the switching control signal G1 transitions from the high voltage level to the low voltage level to the moment when the inductor current IL crosses essentially zero for the second time as the demagnetization time tdmg of the inductor L1, and to provide the demagnetization time signal Tdmg indicating the demagnetization time tdmg of the inductor L1. In other words, in these examples, the timing circuit 14 determines the second zero-crossing point of the inductor current IL (e.g., time t4 shown in FIG. 2) as the end of the demagnetization.

The switching control circuit 15 is configured to receive the demagnetization time signal Tdmg, and to provide the switching control signal G1 based on the demagnetization time signal Tdmg, an on-period signal Ton, and the feedback voltage signal VFB to control the first switch Q1. The on-period signal Ton indicates the on-period ton of the switching control signal G1. In some embodiments, the on-period signal Ton is a fixed value obtained by the switching control circuit 15 based on the feedback voltage signal VFB. In other embodiments, the on-period signal Ton may be provided by users via a data interface according to practical applications. In the embodiment shown in FIG. 2, the on-period ton of the switching control signal G1 is the duration when the switching control signal G1 is at the high voltage level. Therefore, the on-period signal Ton can be obtained by detecting the duration when the switching control signal G1 is at the high voltage level. In one example, the timing circuit 14 is configured to receive the switching control signal G1, and to measure the duration when the switching control signal G1 is at the high voltage level to provide the on-period signal Ton.

In one embodiment, when the ratio of the demagnetization time signal Tdmg to the on-period signal Ton is smaller than a stop threshold Kstop, the switching control circuit 15 provides the switching control signal G1 based on the feedback voltage signal VFB to control the switching operation (i.e., the turn on and off) of the first switch Q1. It should be understood that, the switching operation of the first switch Q1 refers that the first switch Q1 is turned on and off alternately. In another embodiment, when the ratio of the demagnetization time signal Tdmg to the on-period signal Ton is larger than the stop threshold Kstop, the switching control signal G1 turns off the first switch Q1 and stops the switching operation of the first switch Q1.

The switching control circuit 15 is also configured to receive the input rectified voltage Vin, and to provide the switching control signal G1 to turn on the first switch Q1 and to resume the switching operation of the first switch Q1 based on the input rectified voltage Vin. In one embodiment, when the input rectified voltage Vin decreases to the value of the input rectified voltage Vin at the moment when the first switch Q1 stops the switching operation, the switching control signal G1 is configured to turn on the first switch Q1 and to resume the switching operation of the first switch Q1.

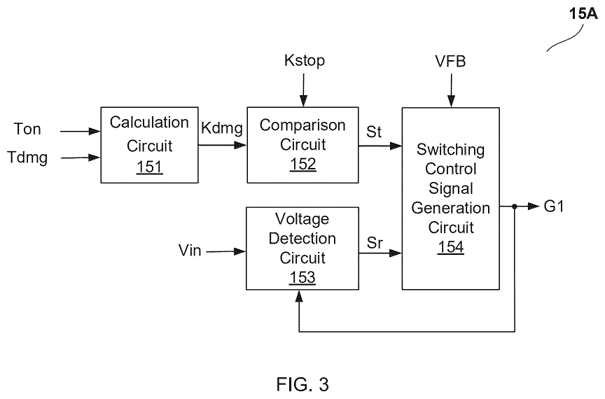

FIG. 3 schematically shows a schematic circuit diagram of a switching control circuit 15A in accordance with one embodiment of the present disclosure. In the embodiment of FIG. 3, the switching control circuit 15A includes a calculation circuit 151, a comparison circuit 152, a voltage detection circuit 153, and a switching control signal generation circuit 154. The calculation circuit 151 is configured to receive the demagnetization time signal Tdmg and the on-period signal Ton, and to provide a ratio signal Kdmg indicating the ratio of the demagnetization time signal Tdmg to the on-period signal Ton. The comparison circuit 152 is configured to receive the ratio signal Kdmg and the stop threshold Kstop, and to provide a first indicating signal St based on the ratio signal Kdmg and the stop threshold Kstop. It should be understood by persons skilled in the art that the value of the stop threshold Kstop could be set based on the parameters and requirements of the specific application. The voltage detection circuit 153 is configured to receive the input rectified voltage Vin and the switching control signal G1, and to provide a second indicating signal Sr based on the input rectified voltage Vin and the switching control signal G1. The switching control signal generation circuit 154 is configured to receive the first indicating signal St, the second indicating signal Sr, and the feedback voltage signal VFB indicating the output voltage Vout, and to generate the switching control signal G1 based on the first indicating signal St, the second indicating signal Sr, and the feedback voltage signal VFB.

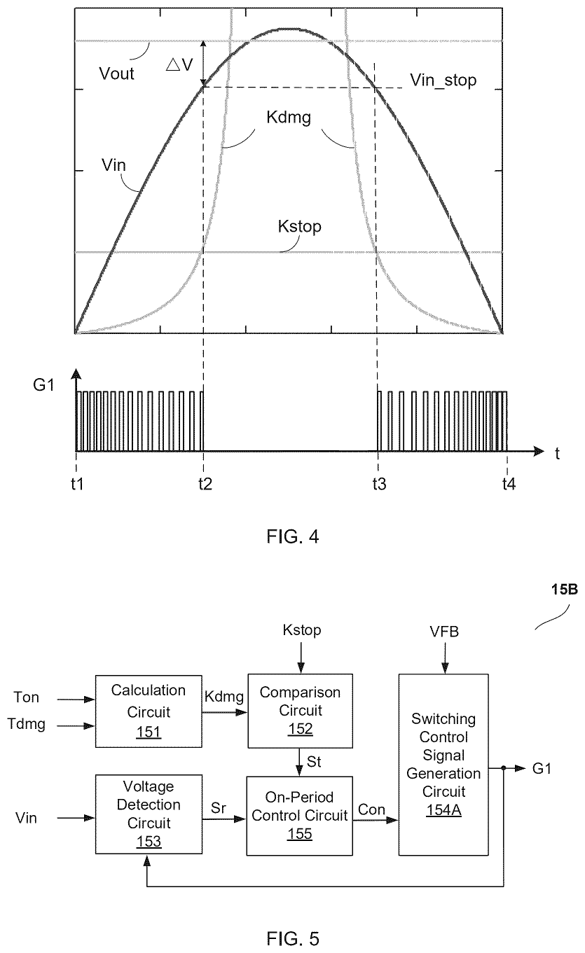

FIG. 4 schematically shows a simulated waveform illustrating the working principle of the boost PFC circuit 100 in accordance with one embodiment of the present disclosure. The working principle of the boost PFC circuit 100 adopting the switching control circuit 15A is illustrated below with reference to FIGS. 1, 3, and 4.

When the ratio signal Kdmg is smaller than the stop threshold Kstop, the switching control signal generation circuit 154 generates the switching control signal G1 to control the switching operation of the first switch Q1 based on the feedback voltage signal VFB indicating the output voltage Vout. As shown in FIG. 4, during time t1-t2, the switching control signal G1 transitions between the high voltage level and the low voltage level to turn on or turn off the first switch Q1. As the input rectified voltage Vin gradually approaches the output voltage Vout, the ratio signal Kdmg also gradually increases.

When the first indicating signal St indicates that the ratio signal Kdmg is larger than the stop threshold Kstop, the difference between the input rectified voltage Vin and the output voltage Vout is lower than a safe threshold voltage AV. Consequently, the switching control signal G1 turns off the first switch Q1 and stops the switching operation of the first switch Q1. At time t2 shown in FIG. 4, the switching control signal G1 transitions to the low voltage level to turn off the first switch Q1. At the same time, the voltage detection circuit 153 detects and records the value of the input rectified voltage Vin (e.g., Vin_stop shown in FIG. 4) at the moment when the first switch Q1 stops the switching operation.

When the second indicating signal Sr indicates that the input rectified voltage Vin is lower than the value of the input rectified voltage Vin (e.g., Vin_stop shown in FIG. 4) at the moment when the first switch Q1 stops the switching operation, the switching control signal G1 is configured to turn on the first switch Q1 and to resume the switching operation of the first switch Q1. As shown in FIG. 4, during time t2-t3, the switching control signal G1 is at the low voltage level, the first switch Q1 is turned off. At time t3, the switching control signal G1 transitions to the high voltage level to turn on the first switch Q1.

After resuming the switching operation of the first switch Q1, the switching control signal generation circuit 154 generates the switching control signal G1 based on the feedback voltage signal VFB to turn on and off of the first switch Q1. As shown in FIG. 4, during time t3-t4, the switching control signal G1 transitions between the high voltage level and the low voltage level to turn on and off of the first switch Q1.

FIG. 5 schematically shows a schematic block diagram of a switching control circuit 15B in accordance with another embodiment of the present disclosure. The switching control circuit 15B includes the calculation circuit 151, the comparison circuit 152, the voltage detection circuit 153, an on-period control circuit 155, and a switching control signal generation circuit 154A. The working principles of the calculation circuit 151, the comparison circuit 152, and the voltage detection circuit 153 are same as those in the embodiment of FIG. 3 and will not be repeated here for brevity. The on-period control circuit 155 is configured to receive the first indicating signal St provided by the comparison circuit 152 and the second indicating signal Sr provided by the voltage detection circuit 153. The on-period control circuit 155 is further configured to provide an on-period control signal Con to control the on-period ton of the switching control signal G1 based on the first indicating signal St and the second indicating signal Sr. The switching control signal generation circuit 154A is configured to receive the on-period control signal Con and the feedback voltage signal VFB, and to provide the switching control signal G1 based on the on-period control signal Con and the feedback voltage signal VFB.

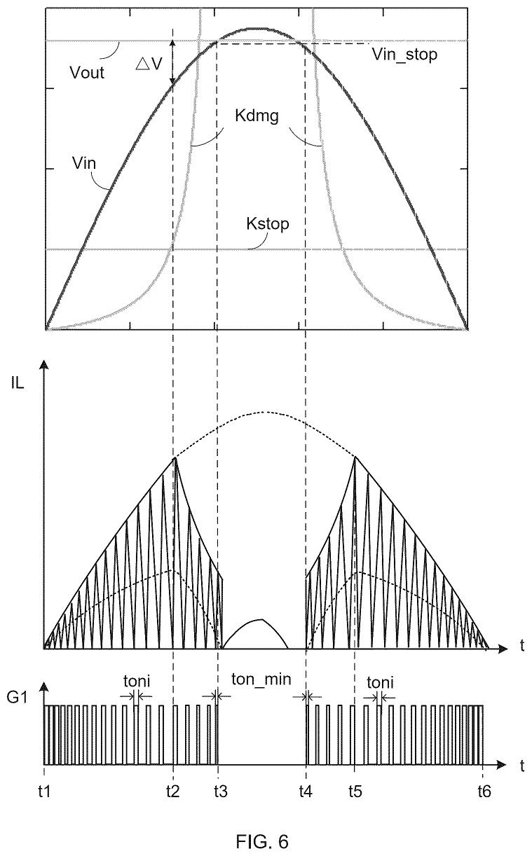

FIG. 6 schematically shows a simulated waveform illustrating the working principle of the boost PFC circuit 100 in accordance with another embodiment of the present disclosure. The working principle of the boost PFC circuit 100 adopting the switching control circuit 15B is illustrated below with reference to FIGS. 1, 5, and 6.

When the ratio signal Kdmg is smaller than the stop threshold Kstop, the switching control signal generation circuit 154A generates the switching control signal G1 to control the switching operation of the first switch Q1 based on the feedback voltage signal VFB indicating the output voltage Vout. In some embodiments, the on-period ton of the switching control signal G1 is the fixed value (e.g., an initial on-period toni shown in FIG. 6) which is calculated based on the feedback voltage signal VFB. During time t1-t2 shown in FIG. 6, the switching control signal G1 has the constant initial on-period toni. The switching control signal G1 transitions between the high voltage level and the low voltage level to turn on and off of the first switch Q1. When the switching control signal G1 transitions to the high voltage level, the first switch Q1 is turned on, the inductor current IL increases. When the initial on-period toni of the switching control signal G1 ends, the switching control signal G1 transitions to the low voltage level, the first switch Q1 is turned off, and the inductor current IL decreases. By controlling the turning on and off of the first switch Q1, the average of the inductor current IL could be shaped to follow the waveform of the input rectified voltage Vin, thereby achieving the power factor correction function. As the input rectified voltage Vin gradually approaches the output voltage Vout, the ratio signal Kdmg also gradually increases.

When the first indicating signal St indicates that the ratio signal Kdmg is larger than the stop threshold Kstop, the difference between the input rectified voltage Vin and the output voltage Vout is lower than the safe threshold voltage AV. The on-period control circuit 155 provides the on-period control signal Con to gradually decrease the on-period ton of the switching control signal G1. In one embodiment, the on-period control circuit 155 provides the on-period control signal Con to decrease the on-period ton of the switching control signal G1. As shown in FIG. 6, during time t2-t3, the on-period ton of the switching control signal G1 gradually decreases from the initial on-period toni to a minimum on-period ton_min. As the on-period ton of the switching control signal G1 decreases, the average of the inductor current IL gradually decreases.

When the minimum on-period ton_min of the switching control signal G1 ends (e.g., at time t3 shown in FIG. 6), the switching control signal G1 transitions to the low voltage level, the first switch Q1 is turned off and the first switch Q1 stops the switching operation. At the same time, the voltage detection circuit 153 detects and records the value of the input rectified voltage Vin (e.g., Vin_stop shown in FIG. 6) at the moment when the first switch Q1 stops the switching operation.

When the second indicating signal Sr indicates that the input rectified voltage Vin is lower than the value of the input rectified voltage Vin (e.g., Vin_stop shown in FIG. 6) at the moment when the first switch Q1 stops the switching operation, the on-period control circuit 155 provides the on-period control signal Con to gradually increase the on-period ton of the switching control signal G1 based on the second indicating signal Sr. In one embodiment, the on-period control circuit 155 increases the on-period control signal Con to increase the on-period ton of the switching control signal G1. As shown in FIG. 6, during time t3-t4, the switching control signal G1 is at the low voltage level, the first switch Q1 is turned off. At time t4, the switching control signal G1 transitions to the high voltage level, the first switch Q1 is turned on and the switching operation of the first switch Q1 is resumed. During time t4-t5, the on-period ton of the switching control signal G1 gradually increases from the minimum on-period ton_min to the initial on-period toni. As the on-period ton of the switching control signal G1 increases, the average of the inductor current IL gradually increases.

After the on-period ton of the switching control signal G1 increases to the initial on-period toni, the switching control signal generation circuit 154 generates the switching control signal G1 to control the switching operation of the first switch Q1 based on the feedback voltage signal VFB. As shown in FIG. 6, at time t5, the on-period ton of the switching control signal G1 increases to the initial on-period toni. During time t5-t6 shown in FIG. 6, the on-period ton of the switching control signal G1 maintains the initial on-period toni. The switching control signal G1 transitions between the high voltage level and the low voltage level to turn on and off of the first switch Q1.

It should be understood by persons skilled in the art that the value of the minimum on-period ton_min and the increased/decreased value of the on-period ton could be set based on the parameters and requirements of the practical application.

In summary, the switching control circuit 15B for the boost PFC circuit 100 has soft off and soft on functions. Specifically, the switching control circuit 15B controls the first switch Q1 to enter the soft off mode based on the demagnetization time signal Tdmg and the on-period signal Ton. When the first switch Q1 enters the soft off mode, the on-period ton of the switching control signal G1 gradually decreases (e.g., during time t2-t3 shown in FIG. 6), thereby gradually decreasing the average of the inductor current IL. The switching control circuit 15B further controls the first switch Q1 to enter the soft on mode based on the input rectified voltage Vin. When the first switch Q1 enters the soft on mode, the on-period ton of the switching control signal G1 gradually increases (e.g., during time t4-t5 shown in FIG. 6), thereby gradually increasing the average of the inductor current IL. Therefore, the boost PFC circuit 100 adopting the switching control circuit 15B could mitigate noise issues caused by abrupt change of the inductor current IL.

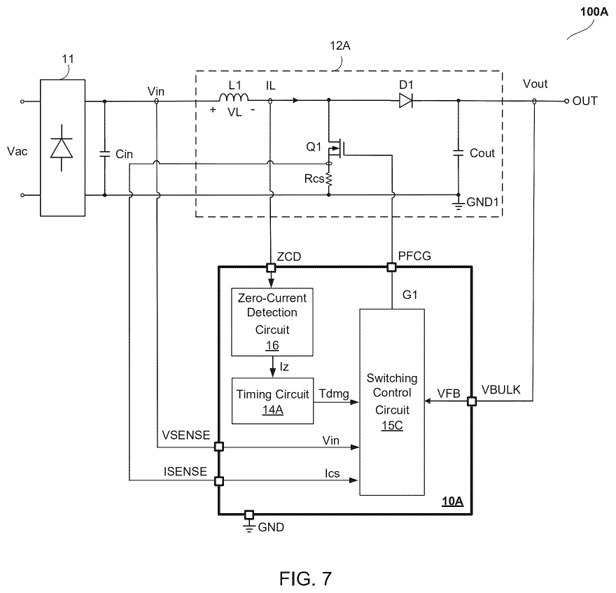

FIG. 7 schematically shows a schematic circuit diagram of a boost PFC circuit 100A in accordance with another embodiment of the present disclosure. In the embodiment of FIG. 7, the boost PFC circuit 100A includes the rectifying circuit 11, a boost conversion circuit 12A, and a control circuit 10A. As illustrated above, the demagnetization time tdmg of the inductor L1 could be obtained based on the inductor current IL flowing through inductor L1. Therefore, in the embodiment of FIG. 7, the control circuit 10A is configured to obtain the demagnetization time tdmg of the inductor L1 to control the first switch Q1 based on the inductor current IL flowing through the inductor L1.

As shown in FIG. 7, the control circuit 10A includes a zero-current detection circuit 16, a timing circuit 14A, a switching control circuit 15C, and a plurality of terminals. Compared to the embodiment of FIG. 1, in the embodiment of FIG. 7, the plurality of terminals of the control circuit 10A include a zero-current detection terminal ZCD and a current sense terminal ISENSE. The zero-current detection terminal ZCD is configured to receive the inductor current IL flowing through the inductor L1. In one embodiment, the zero-current detection terminal ZCD is coupled in series with the inductor L1 to receive the inductor current IL. In another embodiment, the zero-current detection terminal ZCD may be coupled between the second terminal of the first switch Q1 and the rectifying circuit 11 to receive the inductor current IL. The current sense terminal ISENSE is configured to receive a current sense signal Ics indicating the current flowing through the first switch Q1. In one embodiment, the current sense signal Ics is obtained by using a current sense resistor Rcs which is coupled between the second terminal of the first switch Q1 and the reference ground GND1.

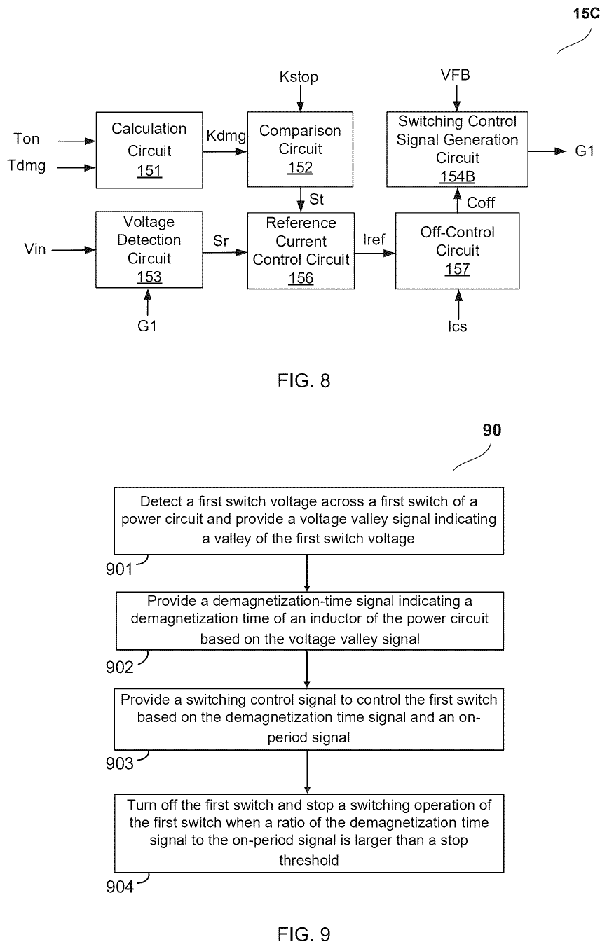

The zero-current detection circuit 16 is configured to detect the inductor current IL flowing through the inductor L1 of the boost PFC circuit 100A, and to provide a zero-crossing signal Iz to indicate the zero-crossing event of the inductor current IL. In one embodiment, the zero-crossing signal Iz provides a pulse when the inductor current IL crosses essentially zero. The timing circuit 14A is configured to provide the demagnetization time signal Tdmg indicating the demagnetization time tdmg of the inductor L1 based on the zero-crossing signal Iz. As illustrated above, the timing circuit 14 may determine the second zero-crossing point of the inductor current IL (e.g., time t4 shown in FIG. 2) or other suitable time before or after the first zero-crossing point of the inductor current IL as the end of the demagnetization. The switching control circuit 15C is configured to provide the switching control signal G1 to control the first switch Q1 based on the demagnetization time signal Tdmg, the on-period signal Ton, the input rectifying voltage Vin, the current sense signal Ics, and the feedback voltage signal VFB. The switching control circuit 15C for the boost PFC circuit 100A may also be configured to have soft off and soft on functions as illustrated in FIG. 6. The working principle of the switching control circuit 15C will be described with reference to FIG. 8.

FIG. 8 schematically shows a schematic circuit diagram of the switching control circuit 15C shown in FIG. 7 in accordance with one embodiment of the present disclosure. As shown in FIG. 8, the switching control circuit 15C includes the calculation circuit 151, the comparison circuit 152, the voltage detection circuit 153, a reference current control circuit 156, an off-control circuit 157, and a switching control signal generation circuit 154B. The working principles of the calculation circuit 151, the comparison circuit 152, and the voltage detection circuit 153 are same as those in the above embodiments and will not be repeated here for brevity.

The reference current control circuit 156 is configured to receive the first indicating signal St provided by the comparison circuit 152 and the second indicating signal Sr provided by the voltage detection circuit 153, and to provide a reference current signal Iref based on the first indicating signal St and the second indicating signal Sr. The off-control circuit 157 is configured to receive the reference current signal Iref and the current sense signal Ics, and to provide an off-control signal Coff to control the on-period ton of the switching control signal G1 based on the reference current signal Iref and the current sense signal Ics. The switching control signal generation circuit 154B is configured to receive the off-control signal Coff, and to generate the switching control signal G1 based on the off-control signal Coff. In some embodiments, when the current sense signal Ics increases to the reference current signal Iref, the off-control circuit 157 provides the off-control signal Coff, the switching control signal G1 transitions to the low voltage level, the first switch Q1 is turned off.

In one embodiment, when the first indicating signal St indicates that the ratio signal Kdmg is larger than the stop threshold Kstop, the reference current signal Iref gradually decreases. Consequently, the duration when the current sense signal Ics increases to the reference current signal Iref gradually shortens, thereby decreasing the on-period ton of the switching control signal G1. When the reference current signal Iref decreases to zero, the switching control signal G1 maintains the low voltage level, the first switch Q1 is turned off, and the switching operation of the first switch Q1 is stopped. In another embodiment, when the second indicating signal Sr indicates that the input rectified voltage Vin is lower than the value of the input rectified voltage Vin at the moment when the first switch Q1 stops the switching operation, the switching control signal G1 transitions to the high voltage level, the first switch Q1 is turned on and the switching operation of the first switch Q1 is resumed. At the same time, the reference current signal Iref gradually increases. Consequently, the duration when the current sense signal Ics increases to the reference current signal Iref gradually prolongs, thereby increasing the on-period ton of the switching control signal G1. In other words, in the embodiment of FIG. 7, the control of the on-period ton of the switching control signal G1 could be realized by adjusting the reference current signal Iref, thereby achieving the soft on and soft off functions as illustrated in FIG. 6.

It should be understood that other control circuits capable of achieving the soft off and/or soft on function may also be utilized in the present disclosure. For example, a control circuit may achieve the soft off and/or soft on function by adjusting a reference current for the inductor current IL. When the inductor current IL increases to the reference current, the switching control signal G1 transitions to the low voltage level, the first switch Q1 is turned off. To be specific, when the first indicating signal St indicates that the ratio signal Kdmg is larger than the stop threshold Kstop, the reference current of the inductor current IL gradually decreases. Therefore, the duration when the inductor current IL increases to the reference current is shortened, and the on-period ton of the switching control signal G1 is decreased. When the second indicating signal Sr indicates that the input rectified voltage Vin is lower than the value of the input rectified voltage Vin at the moment when the first switch Q1 stops the switching operation, the reference current of the inductor current IL gradually increases. Therefore, the duration when the inductor current IL increases to the reference current is prolonged, and the on-period ton of the switching control signal G1 is increased.

The above embodiments are described with reference to the boost PFC circuit to illustrate the working principles of the control circuits. It should be understood that the control circuits of the embodiments disclosed herein are applicable to other power circuits including the boost conversion circuits.

FIG. 9 shows a flowchart of a method 90 for controlling a power circuit in accordance with one embodiment of the present disclosure. The method 90 includes actions 901-904.

In action 901, a first switch voltage across a first switch of the power circuit is detected, and a voltage valley signal indicating the valley of the first switch voltage is provided.

In action 902, a demagnetization time signal indicating the demagnetization time of an inductor of the power circuit is provided based on the voltage valley signal.

In action 903, a switching control signal is provided to control the first switch based on the demagnetization time signal and an on-period signal.

In action 904, when the ratio of the demagnetization time signal to the on-period signal is higher than a stop threshold, the first switch is turned off and the switching operation of the first switch is stopped.

In some embodiments, method 90 further includes the following action. An input rectified voltage of the power circuit is received. When the input rectified voltage of the power circuit is lower than the value of the input rectified voltage at the moment when the first switch stops the switching operation, the first switch is turned on and the switching operation of the first switch is resumed.

In one embodiment, when the ratio of the demagnetization time signal to the on-period signal is larger than the stop threshold, the on-period of the switching control signal is gradually decreased. In one embodiment, the on-period of the switching control signal is gradually decreased to a minimum on-period. When the minimum on-period ends, the first switch is turned off and the switching operation of the first switch is stopped.

In one embodiment, when the input rectified voltage is lower than the value of the input rectified voltage at the moment when the first switch stops the switching operation, the on-period of the switching control signal gradually increases. In one embodiment, when the input rectified voltage is lower than the value of the input rectified voltage at the moment when the first switch stops the switching operation, the on-period of the switching control signal gradually increases from the minimum on-period.

It is noted that the actions of the method 90 can also perform in a different sequence. For example, two consecutive blocks shown in FIG. 9, in fact, can be executed substantially concurrently, or they may sometimes be executed in the reverse order, depending upon the particular function involved.

In the present invention, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A control circuit for a power circuit having a first switch, wherein the control circuit comprises:
a valley detection circuit configured to detect a first switch voltage across the first switch, and to provide a voltage valley signal indicating a valley of the first switch voltage;
a timing circuit configured to provide a demagnetization time signal indicating a demagnetization time of an inductor of the power circuit based on the voltage valley signal; and
a switching control circuit configured to provide a switching control signal to control the first switch based on the demagnetization time signal and an on-period signal; wherein
when a ratio of the demagnetization time signal to the on-period signal is larger than a stop threshold, the switching control signal is configured to turn off the first switch and stop a switching operation of the first switch.

2. The control circuit of claim 1, wherein:
when the ratio of the demagnetization time signal to the on-period signal is larger than the stop threshold, an on-period of the switching control signal starts to decrease.

3. The control circuit of claim 2, wherein the on-period of the switching control signal has a constant initial on-period.

4. The control circuit of claim 1, wherein:
the switching control circuit is further configured to receive an input rectified voltage of the power circuit, and wherein when the input rectified voltage is lower than a value of the input rectified voltage at a moment when the first switch stops the switching operation, the switching control signal is configured to resume the switching operation of the first switch.

5. The control circuit of claim 4, wherein:
when the input rectified voltage is lower than the value of the input rectified voltage at the moment when the first switch stops the switching operation, an on-period of the switching control signal starts to increase.

6. The control circuit of claim 4, wherein the switching control circuit comprises:
a calculation circuit configured to receive the demagnetization time signal and the on-period signal, and to provide a ratio signal indicating the ratio of the demagnetization time signal to the on-period signal;
a comparison circuit configured to receive the ratio signal and the stop threshold, and to provide a first indicating signal based on the ratio signal and the stop threshold;
a voltage detection circuit configured to receive the input rectified voltage and the switching control signal, and to provide a second indicating signal based on the input rectified voltage and the switching control signal; and
a switching control signal generation circuit configured to receive the first indicating signal and the second indicating signal, and to generate the switching control signal based on the first indicating signal and the second indicating signal; wherein
when the first indicating signal indicates that the ratio signal is larger than the stop threshold, the switching control signal is configured to turn off the first switch and stop the switching operation of the first switch; and
when the second indicating signal indicates that the input rectified voltage is lower than the value of the input rectified voltage at the moment when the first switch stops the switching operation, the switching control signal is configured to resume the switching operation of the first switch.

7. The control circuit of claim 4, wherein the switching control circuit comprises:
a calculation circuit configured to receive the demagnetization time signal and the on-period signal, and to provide a ratio signal indicating the ratio of the demagnetization time signal to the on-period signal;
a comparison circuit configured to receive the ratio signal and the stop threshold, and to provide a first indicating signal based on the ratio signal and the stop threshold;
a voltage detection circuit configured to receive the input rectified voltage and the switching control signal, and to provide a second indicating signal based on the input rectified voltage and the switching control signal;
an on-period control circuit configured to receive the first indicating signal and the second indicating signal, and to provide an on-period control signal to control an on-period of the switching control signal based on the first indicating signal and the second indicating signal; and
a switching control signal generation circuit configured to receive the on-period control signal, and to generate the switching control signal based on the on-period control signal; wherein
when the first indicating signal indicates that the ratio signal is larger than the stop threshold, the on-period control signal is configured to decrease the on-period of the switching control signal; and
when the second indicating signal indicates that the input rectified voltage is lower than the value of the input rectified voltage at the moment when the first switch stops the switching operation, the on-period control signal is configured to increase the on-period of the switching control signal.

8. The control circuit of claim 4, wherein the switching control circuit comprises:
a calculation circuit configured to receive the demagnetization time signal and the on-period signal, and to provide a ratio signal indicating the ratio of the demagnetization time signal to the on-period signal;
a comparison circuit configured to receive the ratio signal and the stop threshold, and to provide a first indicating signal based on the ratio signal and the stop threshold;
a voltage detection circuit configured to receive the input rectified voltage and the switching control signal, and to provide a second indicating signal based on the input rectified voltage and the switching control signal;
a reference current control circuit configured to receive the first indicating signal and the second indicating signal, and to provide a reference current signal based on the first indicating signal and the second indicating signal;
an off-control circuit configured to receive the reference current signal and a current sense signal indicating a current flowing through the first switch, and to provide an off-control signal to control an on-period of the switching control signal based on the reference current signal and the current sense signal; and
a switching control signal generation circuit configured to receive the off-control signal, and to generate the switching control signal based on the off-control signal; wherein
when the first indicating signal indicates that the ratio signal is larger than the stop threshold, the reference current signal decreases to decrease the on-period of the switching control signal; and
when the second indicating signal indicates that the input rectified voltage is lower than the value of the input rectified voltage at the moment when the first switch stops the switching operation, the reference current signal increases to increase the on-period of the switching control signal.

9. A control circuit for a boost power factor correction (PFC) circuit having a first switch, wherein the control circuit comprises:
a zero-current detection circuit configured to detect an inductor current flowing through an inductor of the boost PFC circuit, and to provide a zero-crossing signal indicating the inductor current reaches essentially zero;
a timing circuit configured to provide a demagnetization time signal indicating a demagnetization time of the inductor based on the zero-crossing signal; and
a switching control circuit configured to provide a switching control signal to control the first switch based on the demagnetization time signal and an on-period signal; wherein
the switching control circuit is configured to determine whether to control the first switch to enter a soft-off mode based on the demagnetization time signal and the on-period signal, and when the first switch enters the soft-off mode, an on-period of the switching control signal gradually decreases.

10. The control circuit of claim 9, wherein when a ratio of the demagnetization time signal to the on-period signal is larger than a stop threshold, the switching control circuit is configured to control the first switch to enter the soft-off mode.

11. The control circuit of claim 9, wherein:
the switching control circuit is further configured to receive an input rectified voltage of the boost PFC circuit, and to determine whether to control the first switch to enter a soft-on mode based on the input rectified voltage, and when the first switch enters the soft-on mode, the on-period of the switching control signal gradually increases.

12. The control circuit of claim 11, wherein when the on-period of the switching control signal decreases to a minimum on-period, the switching control signal is configured to stop a switching operation of the first switch, and when the input rectified voltage is lower than a value of the input rectified voltage at a moment when the first switch stops the switching operation, the switching control circuit is configured to control the first switch to enter the soft-on mode.

13. The control circuit of claim 11, wherein the switching control circuit comprises:
a calculation circuit configured to receive the demagnetization time signal and the on-period signal, and to provide a ratio signal indicating a ratio of the demagnetization time signal to the on-period signal;
a comparison circuit configured to receive the ratio signal and a stop threshold, and to provide a first indicating signal based on the ratio signal and the stop threshold;
a voltage detection circuit configured to receive the input rectified voltage and the switching control signal, and to provide a second indicating signal based on the input rectified voltage and the switching control signal;
an on-period control circuit configured to receive the first indicating signal and the second indicating signal, and to provide an on-period control signal to control the on-period of the switching control signal based on the first indicating signal and the second indicating signal; and
a switching control signal generation circuit configured to receive the on-period control signal, and to generate the switching control signal based on the on-period control signal.

14. The control circuit of claim 11, wherein the switching control circuit comprises:
a calculation circuit configured to receive the demagnetization time signal and the on-period signal, and to provide a ratio signal indicating a ratio of the demagnetization time signal to the on-period signal;
a comparison circuit configured to receive the ratio signal and a stop threshold, and to provide a first indicating signal based on the ratio signal and the stop threshold;
a voltage detection circuit configured to receive the input rectified voltage and the switching control signal, and to provide a second indicating signal based on the input rectified voltage and the switching control signal;
a reference current control circuit configured to receive the first indicating signal and the second indicating signal, and to provide a reference current signal based on the first indicating signal and the second indicating signal;
an off-control circuit configured to receive a current sense signal indicating a current flowing through the first switch and the reference current signal, and to provide an off-control signal to control the on-period of the switching control signal based on the current sense signal and the reference current signal; and
a switching control signal generation circuit configured to receive the off-control signal, and to generate the switching control signal based on the off-control signal.

15. The control circuit of claim 9, wherein the on-period of the switching control signal has a constant initial on-period.

16. A method for controlling a power circuit, comprising:
detecting a first switch voltage across a first switch of the power circuit and providing a voltage valley signal indicating a valley of the first switch voltage;
providing a demagnetization time signal indicating a demagnetization time of an inductor of the power circuit based on the voltage valley signal;
providing a switching control signal to control the first switch based on the demagnetization time signal and an on-period signal; and
turning off the first switch and stopping a switching operation of the first switch when a ratio of the demagnetization time signal to the on-period signal is larger than a stop threshold.

17. The method of claim 16, further comprising:
when the ratio of the demagnetization time signal to the on-period signal is larger than the stop threshold, decreasing an on-period of the switching control signal.

18. The method of claim 17, wherein the on-period of the switching control signal has a constant initial on-period.

19. The method of claim 16, further comprising:
receiving an input rectified voltage of the power circuit; and
turning on the first switch and resuming the switching operation of the first switch when the input rectified voltage is lower than a value of the input rectified voltage at a moment when the first switch stops the switching operation.

20. The method of claim 19, further comprising:
when the input rectified voltage decreases to the value of the input rectified voltage at the moment when the first switch stops the switching operation, increasing an on-period of the switching control signal.
